(19) United States
(12) Patent Application Publication
(10) Pub. No.: US 2021/0135386 A1
(43) Pub. Date: May 6, 2021

(54) CONNECTOR AND METHOD FOR PRODUCING THE SAME

(71) Applicant: YAZAKI CORPORATION, Tokyo (JP)

(72) Inventors: Toshitaka Kubo, Tsukuba-shi (JP); Mitsuhiro Okada, Tsukuba-shi (JP); Tetsuo Shimizu, Tsukuba-shi (JP); Hiroki Kawai, Susono-shi (JP)

(21) Appl. No.: 17/084,608

(22) Filed: Oct. 29, 2020

(30) Foreign Application Priority Data
Nov. 1, 2019 (JP) 2019-199866

(51) Int. Cl. H01R 13/03; H01B 1/18; C25D 7/00; C25D 5/00; C25D 3/48

(52) U.S. Cl. CPC H01R 13/03; H01B 1/18; C25D 3/48; C25D 5/605; C25D 7/00

(57) ABSTRACT

The invention relates to a connector including an electrical contact material which contains a metal base material and a conductive coating layer on a surface of the metal base material, in which the conductive coating layer includes: a matrix phase constituted by a metal other than gold; and a second phase that includes: elongated portions that elongate in a depth direction from a surface of the matrix phase; and enlarged diameter portions that, in the surface of the matrix phase, extend from the elongated portions along the surface, in which the second phase is constituted by gold or a non-metal conductive material that is less oxidizable than the metal constituting the matrix phase.

### CROSS-REFERENCE TO RELATED APPLICATIONS

This application is based on and claims priority under 35 USC 119 from Japanese Patent Application No. 2019-199866 filed on Nov. 1, 2019.

### TECHNICAL FIELD

The present invention relates to a connector and a method for producing the connector.

### BACKGROUND ART

In a connector for connecting electric wires to each other, or connecting an electric wire to an electric apparatus, recently, a miniaturization and a large current are advancing. Therefore, a connector is requested to have a high reliability that, even at a high current density, enables a current to flow through the connector without causing any trouble.

In a connector, usually, the surface (contact surface) of each electrical contact is plated with a metal in order to prevent the conductivity from being lowered by oxidation or the like, and suppress corrosion. In the use environment of a connector, however, metals other than gold are oxidized in varying degrees. Even when a contact surface is plated with such a metal, deterioration is caused by oxidation or the like depending on the use environment and the conditions. Moreover, it is known that, when deterioration is once started, the deterioration progresses at an accelerated rate.

Such deterioration of an electrical contact, particularly, lowering of the conductivity leads to degradation of the reliability such as increase of the power loss or conduction failure in a connector, and therefore is problematic.

By contrast, when the contact surface of an electrical contact is plated with gold, there is almost no possibility that deterioration due to oxidation occurs, but there is a problem in that gold is an expensive material, and therefore the production cost is increased.

In order to suppress oxidation of the surface of an electrical contact or lowering of the conductivity due to the oxidation at low cost, various countermeasures have been studied.

For example JP-A-2018-56119 discloses a material in which layers made of graphene are stacked on a copper foil or a copper substrate is used as the material of an electric contact. JP-A-2018-56119 teaches “In the electrical contact material, the carbon material layer is provided on the base material. Accordingly, using the electrical contact material in the preparation of an electrical contact makes it possible to prevent generation of a metallic oxide film on the base material. Therefore, the electrical contact according to the present invention has excellent contact reliability without hindering conduction.”(Paragraph [0020]).

JP-A-2012-49107 and JP-A-2013-11016 disclose an electrical contact material that is obtained in the following manner. A metal plating film containing a nano-carbon material such as carbon nanotubes (CNTs) is formed on a base material made of copper or an alloy thereof so that at least a part of the carbon nanomaterial is exposed from the surface of the plating film, and at the same time contacted also with a portion of a metal constituting the plating film, the portion being not oxidized. JP-A-2012-49107 teaches “the other conductive member is directly electrically connected to a metal located inside (deep part) the metal plating film 4a through the CNTs 4b having higher electric conductivity than that of the metal oxide film 4c having low electric conductivity. As a result, stably low contact resistance is obtained.”(Paragraph [0025]). JP-A-2013-11016 teaches “ the other conductive member is directly electrically connected to a metal located inside (deep part) the amorphous plating layer 4 through the nanocarbon material 6 having higher electric conductivity than that of the metal oxide film having low electric conductivity. As a result, stably low contact resistance is obtained.”(Paragraph [0028]).

### SUMMARY OF INVENTION

However, in an electrical contact material in which a graphene layer is stacked on the surface of a metal as disclosed in JP-A-2018-56119, when a part of the graphene layer damages or peels off during use, and the metal in the lower layer is exposed, then the metal in the exposed part is oxidized. When oxygen diffuses in the interface between the metal and the graphene layer, and in the metal, the oxidation advances, and a metal oxide film is formed in the interface between the metal and the graphene layer, whereby the conductivity of the electrical contact material is lowered.

In an electrical contact material in which a metal plating film containing a nano-carbon material is formed on a metal base material in a form in which the nano-carbon material is penetrated through an oxide film of the surface of the plating film, as disclosed in JP-A-2012-49107 and JP-A-2013-11016, when the electrical contact material connects to another electrical contact material having a similar structure, only the nano-carbon material that is in contact with a nano-carbon material which is exposed from the surface of a counter electrical contact material functions as an electrical conductive path having a low resistance. Therefore, the effect of improvement of the electrical conductivity is not so large.

In view of the above-described circumstances, a connector or an electrical contact material constituting the connector is requested to suppress lowering of the conductivity due to oxidation of the surface because of a time lapse from the production, or damaging or peeling off of the film that is caused by repeated use. Therefore, it is an object of the invention to provide a connector which solves the above-described problems, and in which the conductivity is maintained for a long period of time.

The inventors has conducted various studies in order to attain the above object, and found that the following conductive coating layer that is disposed on a surface of a metal base material can attain the object, thereby the above object is attained and completing the invention. The conductive coating layer includes: a matrix phase constituted by a metal other than gold; and a second phase that includes: elongated portions that elongate in a depth direction from a surface of the matrix phase; and enlarged diameter portions that, in the surface of the matrix phase, extend from the elongated portions along the surface, in which the second phase is constituted by gold or a non-metal conductive material that is less oxidizable than the metal constituting the matrix phase.

A first embodiment of the invention is a connector includes an electrical contact material which contains a metal base material and a conductive coating layer on a surface of the metal base material, in which the conductive coating layer includes: a matrix phase constituted by a metal other than gold; and a second phase that includes: elongated portions that elongate in a depth direction from a surface of the matrix phase; and enlarged diameter portions that, in the surface of the matrix phase, extend from the elongated portions along the surface, in which the second phase is constituted by gold or a non-metal conductive material that is less oxidizable than the metal constituting the matrix phase.

A second embodiment of the invention is a method for producing the connector according to the first embodiment, the method includes forming the conductive coating layer by: preparing a plating bath containing a component element of the second phase; and performing an electroplating process in which the metal base material is immersed in the plating bath to obtain a plating layer in which the second phase grows in a dendrite-like manner in the matrix phase,

A third embodiment of the invention is a method for producing the connector according to the first embodiment, the method includes forming the conductive coating layer by: preparing a plating bath; performing an electroplating process in which the metal base material is immersed in the plating bath to obtain a porous plating layer constituted by an aggregation of fine particles having a composition of the matrix phase; and filling open pores of the porous plating layer and covering at least a part of the surface of the porous plating layer with a material constituting the second phase or a precursor of the material.

A fourth embodiment of the invention is a method for producing the connector according to the first embodiment, the method includes forming the conductive coating layer by: preparing a plating bath containing a component element of the second phase; and performing an electroplating process in which the metal base material is immersed in the plating bath to obtain a plating layer constituted by fine particles having a composition of the matrix phase, and a material constituting the second phase or a precursor of the material which fill spaces between the fine particles.

A fifth embodiment of the invention is a method for producing the connector according to the first embodiment, the method includes forming the conductive coating layer by: preparing a plating bath containing a component element of the second phase; and performing an electroplating process in which the metal base material is immersed in the plating bath, under conditions where bubbles or convection is formed in the plating bath, to obtain a plating layer that includes the second phase having a shape in which bubbles or stripes are coupled to one another, in the matrix phase.

A sixth embodiment of the invention is a method for producing the connector according to the first embodiment, the method includes forming the conductive coating layer by: preparing powder of the metal constituting the matrix phase; coating surfaces of particles constituting the powder by a material constituting the second phase or a precursor of the material; and placing the powder of the coated particles on the metal base material, and pressing and heating the powder of the coated particles to perform a molding process.

According to the invention, a connector in which the conductivity is maintained for a long period of time can be provided.

### BRIEF DESCRIPTION OF DRAWINGS

FIG. 1 is a diagram showing an example of the microstructure of the connector of the invention.

FIGS. 2A and 2B are diagrams showing another example of the microstructure of the connector of the invention (FIG. 2A shows a state immediately after the production, and FIG. 2B shows a state where oxidation (corrosion) of the surface advances).

FIGS. 3A and 3B are diagrams showing a further example of the microstructure of the connector of the invention (FIG. 3A shows a state immediately after the production, and FIG. 3B shows a state where oxidation (corrosion) of the surface advances).

FIG. 4 is a diagram showing the microstructure of a conductive coating layer that is obtained by a plating process performed on a metal base material, and that includes a matrix phase constituted by fine metal particles, and a second phase filling spaces between the fine particles.

FIG. 5 is a diagram showing the microstructure of a conductive coating layer that is obtained by a plating process performed on a metal base material, and that includes, in a matrix phase, a second phase having a form in which bubbles are coupled to one another.

FIGS. 6A and 6B show observation and analysis results of the surface of a conductive coating layer in a test piece of Example 1 (FIG. 6A shows a scanning electron microscopic (SEM) image, and FIG. 6B shows an Energy Dispersive X-ray spectrometer (EDX) image).

FIGS. 7A and 7B show optical microscopic images of the surface of a porous plating layer that is formed on a metal base material in Example 2 (FIG. 7A shows a state immediately after growth of fine metal particles, and FIG. 7B shows a state where fine metal particles are coupled to one another to become a sponge-like form)

FIGS. 8A and 8B show optical microscopic images of the surface of a conductive coating layer in a test piece of Example 2 (FIG. 8A shows a state where spaces between fine metal particles are filled by graphene immediately after formation of the porous plating layer, and FIG. 8B shows a state where spaces between sponge-like metals are filled by graphene).

FIGS. 9A and 9B show observation and analysis results of the surface of a conductive coating layer in a test piece of Example 3 (FIG. 9A shows an optical microscopic image, and FIG. 9B shows an energy disperse X-ray spectrometer (EDX) image).

FIG. 10 shows an optical microscopic image of the surface of a conductive coating layer in a test piece of Example 4.

### DESCRIPTION OF EMBODIMENTS

Hereinafter, the invention will be described in detail with reference to embodiments. However, the invention is not limited to the embodiments.

### [Connector]

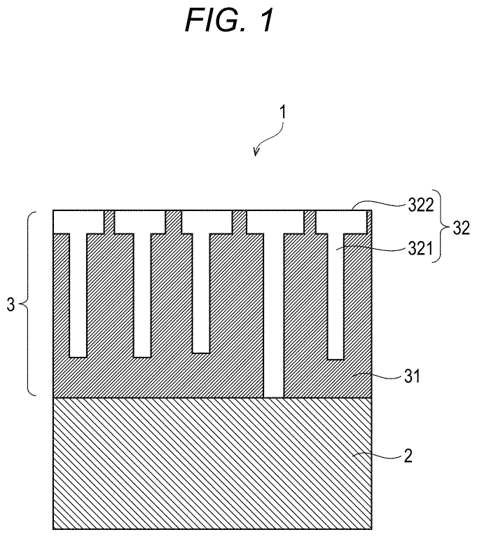

As shown in FIG. 1, a connector of the first embodiment of the invention (hereinafter, referred to merely as “first embodiment”) includes an electrical contact material 1 in which a conductive coating layer 3 is disposed on the surface of a metal base material 2. The conductive coating layer 3 includes a matrix phase 31 and a second phase 32.

The metal base material 2 is required to be electrically conductive, and silver, copper, aluminum, nickel, tin, alloys containing these metals, or the like may be used as the metal base material. Alternatively, stainless steel may be used.

The shape and dimensions of the metal base material 2 may be adequately determined in accordance with the required performance, the standard, and the like. A thickness of the metal base material 2 is preferably 0.1 mm to 3 mm.

The conductive coating layer 3 is an electrically conductive layer that is disposed on the surface of the metal base material 2, and functions so as to ensure electrical conduction between the metal base material 2 and a connected electric apparatus (an electric wire, an electric apparatus, or the like) while suppressing oxidation of the metal base material 2.

The matrix phase 31 in the conductive coating layer 3 is constituted by a metal other than gold. When the matrix phase 31 is constituted by a metal other than gold, it is possible to suppress oxidation of the metal base material 2, and ensure electrical conduction in an internal part of the conductive coating layer 3 while reducing the material cost. Examples of the material of the matrix phase 31 are nickel, cobalt, copper, silver, chromium, zinc, tin, alloys of these metals, or the like. The matrix phase 31 may be crystalline or amorphous.

A thickness of the conductive coating laser 3 is preferably 0.1 μm to 1 mm.

As shown in FIG. 1, the second phase 32 in the conductive coating layer 3 includes elongated portions 321 that elongate in the depth direction from the surface of the matrix phase 31, and enlarged diameter portions 322 that, in the surface of the matrix phase 31, extend from the elongated portions 321 along the surface. The term “elongate in the depth direction” means that the elongated portions are required to have a part that is directed in a direction away from the surface of the matrix phase 31. Therefore, also an elongated portion a part of which is parallel to the surface is included in the elongated portions 321 in the embodiment. The second phase 32 is constituted by gold or a non-metal conductive material that is less oxidizable than the metal constituting the matrix phase 31. Since the second phase 32 includes the elongated portions 321 that are less oxidizable than the matrix phase 31, electrical conduction between the surface of the conductive coating layer 3 and the metal base material 2 can be maintained even in the case where the matrix phase 31 oxidizes and its conductivity is lowered. Moreover, even in the case where the second phase 32 is connected to another electrical contact material having a similar structure, the configuration where the second phase 32 includes the enlarged diameter portions 322 that are less oxidizable than the matrix phase 31 enables an electrical contact between the second phase 32 and the second phase in a counter electrical contact material, to be ensured, and the ratio of the second phase (the elongated portions 321) that functions as an electrically conductive path, to be increased.

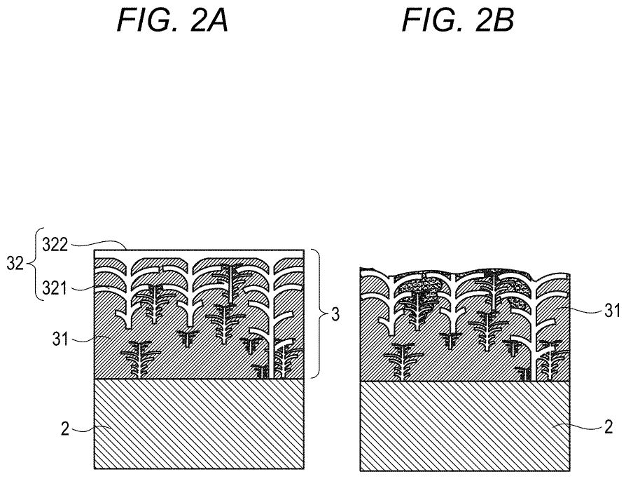

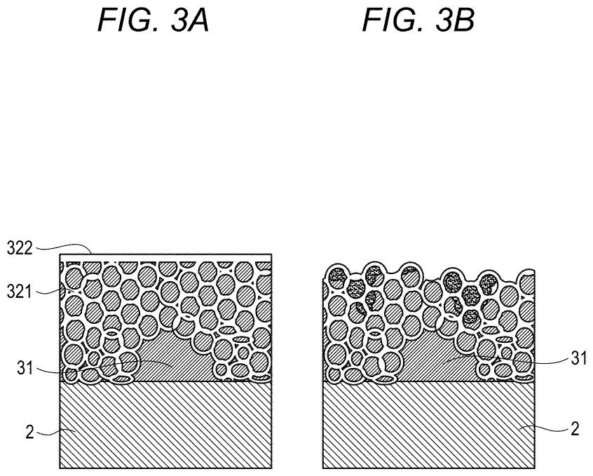

As the structure of the second phase 32, it is possible to adopt a structure that, as shown in FIG. 1, includes: the elongated portions 321 that are formed in an internal part of the conductive coating layer 3 in a manner similar to roots of a plant; and the enlarged diameter portions 322 that extend in the surface of the conductive coating layer 3, or another structure that, as shown in FIG. 2A or FIG. 3A, includes: the elongated portions 321 that are formed in an internal part of the conductive coating layer 3 in a manner similar to leaves or flowers of a plant, or in a three-dimensional net-like manner; and the enlarged diameter portions 322 that are integrally formed, and that cover the whole surface of the conductive coating layer 3. The configuration where the enlarged diameter portions 322 cover the whole surface of the conductive coating layer 3 is preferable because all of the elongated portions 321 that are contacted with the enlarged diameter portions function as an electrically conductive path. The configuration where the elongated portions 321 have a structure similar to leaves or flowers of a plant, or a three-dimensional net-like structure is preferable because of the following reason. Even in the case where, as shown in FIG. 2B or FIG. 3B, the matrix phase 31 in the vicinity of the surface of the conductive coating layer 3 deteriorates with oxidation and collapses, the elongated portions 321 exposed from the surface form new enlarged diameter portions 322, and the electrical contact is ensured.

As described above, the second phase 32 is constituted by gold or a non-metal conductive material that is less oxidizable than the metal constituting the matrix phase 31. Examples as a non-metal conductive material that is less oxidizable than the metal constituting the matrix phase 31 are a carbon material such as graphene or carbon nanotubes (CNTs), an organic electric conductive material, and the like. Among these materials, a carbon material is preferable because it is economical and has a high conductivity. Particularly, graphene and CNTs are more preferable because they are economical, and have high chemical stability and an excellent conductivity. As described above, gold is an expensive material, however in the case where gold is used as the second phase 32, only a small amount is required as compared with the case where the entire coating layer 3 is constituted by gold, and the increase of the production cost is suppressed. Therefore, gold is allowed to be used as the material of the conductive coating layer.

As described above, the connector of the first embodiment includes the conductive coating layer constituted by the matrix phase and the second phase. It is a matter of course that the conductive coating layer may contain components other than the above-mentioned components as far as a desired conductivity and oxidation resistance are obtained.

### [Method for Producing Connector]

A method for producing a connector of the second embodiment of the invention (hereinafter, referred to merely as “second embodiment”) is a method for producing the connector of the above-described first embodiment, in which the conductive coating layer includes: the matrix phase constituted by a metal other than gold; and the second phase that includes: elongated portions that elongate in a depth direction from a surface of the matrix phase; and enlarged diameter portions that, in the surface of the matrix phase, extend from the elongated portions along the surface, in which the second phase is constituted by gold or a non-metal conductive material that is less oxidizable than the metal constituting the matrix phase, the method includes forming the conductive coating layer by: preparing a plating bath containing a component element of the second phase; and performing an electroplating process in which a metal base material is immersed in the plating bath, to obtain a plating layer in which the second phase grows in a dendrite-like manner in the matrix phase.

The plating bath that is used in the second embodiment contains the component element of the second phase. Examples of the forms of the component element of the second phase are fine powder of a carbon material, fine powder having the composition of the second phase such as gold colloid, and ions containing the component element of the second phase. The plating bath may contain, as ions, the metal constituting the matrix phase. The kinds and contained amounts of other components of the plating bath may be adequately determined in accordance with a known method of a plating process.

As a method and conditions of the electroplating process, a known method and conditions of the electroplating process can be adopted in the second embodiment, as far as the conductive coating layer that, is obtained by the growth of the second phase in the matrix phase in a dendrite-like manner, is formed at a predetermined thickness. As the method of the electroplating process, for example, a method in which the metal base material and the metal (plating metal) that is the material of the matrix phase are immersed in the plating bath, and a voltage is applied between them, or another method in which a conductor that is stable (does not dissolve) under plating conditions, and the metal base material are immersed in the plating bath containing ions of the metal constituting the matrix phase, and a voltage is applied between them may be adopted. An example of the process conditions in the former method is that hydrochloric acid containing carbon black that is the component element of the second phase, and a surfactant such as polyoxyalkylene alkyl ether, and having a concentration of about several % is used as the plating bath, the metal base material on which plating is to be performed, and the metal (plating metal) that is the material of the plating layer are immersed in the plating bath, and a voltage lower than several volts is applied between the metal base material and the plating metal.

In the second embodiment, the applied voltage in the electroplating process is preferably 0.1 V to 12 V.

A method for producing a connector of the third embodiment of the invention (hereinafter, referred to merely as “third embodiment”) is a method for producing the connector of the above-described first embodiment, in which the conductive coating layer includes: the matrix phase constituted by a metal other than gold; and the second phase that includes: elongated portions that elongate in a depth direction from a surface of the matrix phase; and enlarged diameter portions that, in the surface of the matrix phase, extend from the elongated portions along the surface, in which the second phase is constituted by gold or a non-metal conductive material that is less oxidizable than the metal constituting the matrix phase, the method includes forming the conductive coating layer by: preparing a plating bath; performing an electroplating process in which a metal base material is immersed in the plating bath to obtain a porous plating layer constituted by an aggregation of fine particles having a composition of the matrix phase; and filling open pores of the porous plating layer and covering at least a part of the surface of the porous plating layer with a material constituting the second phase or a precursor of the material.

In the third embodiment, a method similar to the method of the above-described second embodiment may be adopted as the plating process method. In the third embodiment, however, the configuration where the plating bath contains the component element of the second phase is not essential. An example of the plating process conditions for forming the porous plating layer constituted by an aggregation of fine particles haying a composition of the matrix phase is that hydrochloric acid having a concentration of about several % is used as the plating bath, the metal base material on which plating is to be performed, and the metal (plating metal that constitutes the matrix phase) that is the material of the plating layer are immersed in the plating bath, and a voltage lower than several volts is applied between the metal base material and the plating metal. In this case, the plating bath may contain fine particles such as a trace of carbon particles in the order of nm that become initial cores for precipitating fine metal particles, and a surfactant such as polyoxyalkylene alkyl ether.

In the third embodiment, the applied voltage in the electroplating process is preferably 0.1 V to 12 V.

In the third embodiment, the material constituting the second phase or a precursor of the material is supplied to the porous plating layer formed on the metal base material, open pores of the porous plating layer are filled, and at least a part of the surface of the porous plating layer is coated. The method for supplying the material constituting the second phase or a precursor of the material is not particularly limited. As the method, application or spraying of a solution or slurry, immersion in the solution or slurry, evaporation or sputtering, or the like may be adopted.

In the third embodiment, the plating layer in which the filling of open pores and the coating of the surface are performed by the material constituting the second phase or a precursor of the material may be pressurized and heated. This enables the conductive coating layer to be denser. The pressurizing and heating method is not particularly limited as far as the conductive coating layer can be made denser. Examples of the method are a method in which a uniaxial pressure molding machine having a heater is used, and the hot press method. Also the molding conditions may be adequately determined in accordance with the constituting material and structure of the plating layer, and the like.

In the third embodiment, the second phase is produced from a precursor of the second phase by performing, on the plating layer formed on the metal base material, a post-process such as an oxidation process in which heating is conducted under an oxidizing atmosphere, a reduction process in which heating is conducted under a reduction atmosphere, an oxidation or reduction process based on light or voltage application, or the like, as required.

A method for producing a connector of the fourth embodiment of the invention (hereinafter, referred to merely as “fourth embodiment”) is another embodiment that is based on the technical concept common to the above-described third embodiment, and characterized in that the plating bath for forming the conductive coating layer in the third embodiment is constituted so as to contain the component element of the second phase, and a plating layer constituted by: fine particles having the composition of the matrix phase; and a material constituting the second phase or a precursor of the material which fill spaces between the fine metal particles is obtained by a plating process performed on the metal base material.

In the fourth embodiment, a method similar to the method of the above-described second embodiment may be adopted as the plating method. An example of the plating process conditions for causing fine metal particles having the composition of the second phase to precipitate and grow, and forming the second phase that tills spaces between the fine particles is that hydrochloric acid containing the component element of the second phase, and a surfactant such as polyoxyalkylene alkyl ether, and having a concentration of about several % is used as the plating bath, the metal base material on which plating is to be performed, and the metal (plating metal that constitutes the matrix phase) that is the material of the plating layer are immersed in the plating bath, and a voltage lower than several volts is applied between the metal base material and the plating metal. As the forms of the component element of the second phase that are contained in the plating bath, the forms exemplified in the second embodiment may be adopted. The component element of the second phase having a fine particulate shape is preferable because the fine particles function also as initial cores for precipitating fine metal particles. When the pH of the plating bath, or the size, concentration, or the like of the fine particles is changed, it is possible to control either of the metals constituting the second phase or the matrix phase so as to preferentially crystallize. After the plating process is completed, the plating layer may be pressurized and heated in a method similar to that in the third embodiment, in order to make the plating layer denser, and form the second phase. In a similar manner as the third embodiment, a post-process such as an oxidation or reduction process may be performed on the plating layer formed on the metal base material, as required.

In the fourth embodiment, the applied voltage in the electroplating process is preferably 0.1 V to 12 V.

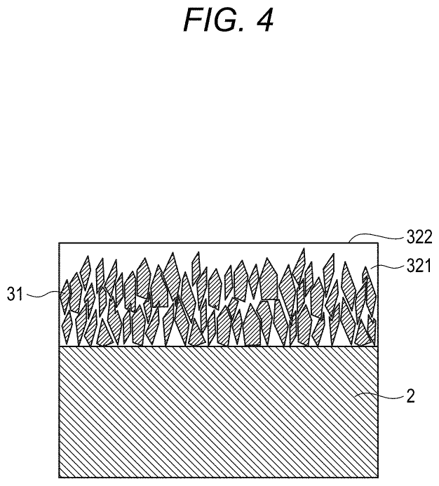

In the third and fourth embodiments, fine metal particles that precipitate and grow on the metal base material, and that have the composition of the matrix phase are used as a template, and the fine metal particles are covered by the material constituting the second phase, whereby the elongated portions that fill between the fine metal particles, and the enlarged diameter portions that cover the elongated portions and the fine metal particles are formed to obtain the second phase. As a result, the conductive coating layer having the microstructure such as shown in FIG. 4 is obtained.

A method for producing a connector of the fifth embodiment of the invention (hereinafter, referred to merely as “fifth embodiment”) is a method for producing the connector of the above-described first embodiment, in which the conductive coating layer includes: the matrix phase constituted by a metal other than gold; and the second phase that includes: elongated portions that elongate in a depth direction from a surface of the matrix phase; and enlarged diameter portions that, in the surface of the matrix phase, extend from the elongated portions along the surface, in which the second phase is constituted by gold or a non-metal conductive material that is less oxidizable than the metal constituting the matrix phase, the method includes forming the conductive coating layer by: preparing a plating bath containing component element of the second phase; and performing an electroplating process in which the metal base material is immersed in the plating bath under conditions where bubbles or convection is formed in the plating bath, to obtain a plating layer that includes the second phase having a shape in which bubbles or stripes are coupled to one another in the matrix phase.

In the fifth embodiment, a method similar to the method of the above-described second embodiment may be adopted as the plating method. An example of the plating process conditions for forming bubbles or convection in the plating bath is that an acidic solution containing the constituting material of the second phase or a precursor of the material is used as the plating bath, the metal base material on which plating is to be performed, and the metal (plating metal that constitutes the matrix phase) that is the material of the plating layer are immersed in the plating bath, and a voltage lower than several volts is applied between the metal base material and the plating metal. Under this method and conditions, hydrogen bubbles that are generated on the surface of the metal base material according to the electrolysis in the plating bath are caused to stay for a certain time period on the surface of the metal base material by the function of the fine particles, without being emitted into the plating bath or the atmosphere. In this case, the hydrogen bubbles function as model forms, and the fine particles deposit on the forms, thereby forming the second phase having the shapes of the hydrogen bubbles. When the hydrogen bubbles emit from the surface of metal base material into the plating bath, the second phase having the shape of convection caused by the emission is formed.

In the fifth embodiment, the applied voltage in the electroplating process is preferably 0.1 V to 12 V.

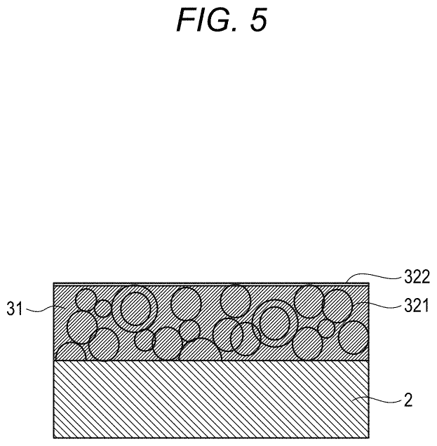

In the fifth embodiment, the constituting material of the second phase are caused to precipitate in a bubble- or stripe-like form by using convection that is generated by the bubble formed in the plating bath, or stirring due thereto, and the generated bubbles or stripes are coupled to one another, whereby the elongated portions and the enlarged diameter portions are formed to obtain the second phase. As a result, the conductive coating layer having the microstructure such as shown in FIG. 5 is obtained.

A method for producing a connector of the sixth embodiment of the invention (hereinafter, referred to merely as “sixth embodiment”) is a method for producing the connector of the above-described first embodiment, in which the conductive coating layer includes: the matrix phase constituted by a metal other than gold; and the second phase that includes: elongated portions that elongate in a depth direction from a surface of the matrix phase; and enlarged diameter portions that, in the surface of the matrix phase, extend from the elongated portions along the surface, in which the second phase is constituted by gold or a non-metal conductive material that is less oxidizable than the metal constituting the matrix phase, the method includes forming the conductive coating layer by: preparing powder of the metal constituting the matrix phase; coating surfaces of particles constituting the powder by a material constituting the second phase or a precursor of the material; and placing the powder of the coated particles on the metal base material, and pressing and heating the powder of the coated particles to perform a molding process.

The metal powder that is used in the sixth embodiment is not limited in particle shape and particle diameter as far as the powder is made of the metal constituting the matrix phase. Examples of the metal powder are atomized powder, coprecipitated powder, and pulverized powder of the metal.

Also the method for coating surfaces of particles constituting the metal powder by the material constituting the second phase or a precursor of the material is not particularly limited, and immersion in a solution or slurry, evaporation or sputtering, or the like may be adopted. In the case where metal powder constituted by metal particles that are previously coated by the material constituting the second phase or a precursor of the material is available, this metal powder may be used.

The method for performing a molding process to metal powder constituted by metal particles coated by the material constituting the second phase or a precursor of the material is not particularly limited as far as the powder and the metal base material on which the powder is placed can be pressed while heating, to be integrated with each other. Examples of the method are a method in which a uniaxial pressure molding machine having a heater is used, and the hot press method. Also the molding conditions may be adequately determined in accordance with the kinds of the metal base material and metal powder that are used.

In the case where the material covering the metal particles is not the material itself constituting the second phase but a precursor of the material, the second phase is obtained by performing a post-process after the molding. Examples of the post-process are an oxidation process in which heating is conducted under an oxidizing atmosphere, a reduction process in which heating is conducted under a reduction atmosphere, and an oxidation or reduction process based on light or voltage application.

### EXAMPLES

Hereinafter, the embodiments of the invention will be described further specifically based on examples. However, the invention is not limited at all by the examples.

### Example 1

The conductive coating layer was formed on the metal base material in a method corresponding to the above-described second embodiment.

First, a copper plate (manufactured by The Nilaco Corporation) of 10 mm×10 mm×1 mm was prepared as the metal base material, a tin alloy wire (Sn: 99.3%, Cu Ni: 0.7%) of 1 mm Φ was prepared as the plating metal, and a dispersion liquid in which carbon black (manufactured by KURETAKE Co., Ltd.) is dispersed in 2% hydrochloric acid containing polyoxyalkylene alkyl ether that is a surfactant was prepared as the plating bath. Then, the copper plate and the tin alloy wire were immersed in the plating bath, a voltage of 0.7 V was applied between them, and a plating process was performed under conditions of a current value of 0.01 A and 15 minutes, to form the conductive coating layer, whereby a test piece of Example 1 was obtained.

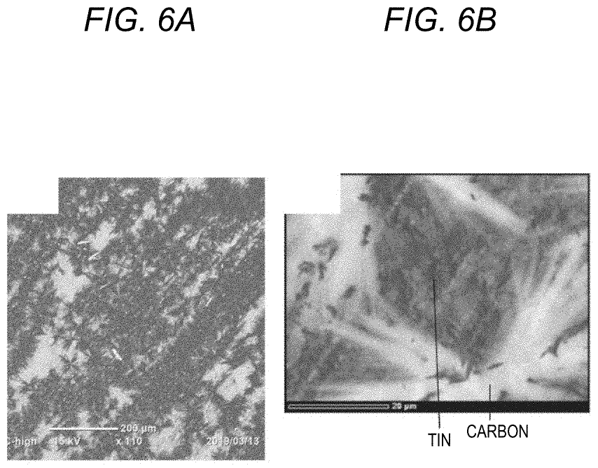

The surface of the conductive coating layer of the obtained test piece of Example 1 was observed with a scanning electron microscopic (SEM) (manufactured by JEOL Ltd., JCM-6000Plus NeoScope™). As a result, it was confirmed that the dendrite-like second phase spreads along the surface of the matrix phase in a manner similar to leaves or flowers of a plant. The composition of the conductive coating layer was checked by an energy disperse X-ray spectrometer (EDX) that is attached to the SEM, and it was confirmed that the matrix phase contains tin as a main component, and the second phase contains carbon as a main component. Moreover, also in places where it was not confirmed that the second phase exists in the surface, there was a case where a peak of carbon was observed by the EDX. Therefore, it can be said that the second phase grows in the matrix phase in the thickness direction of the conductive coating layer, in a manner similar to roots of a plant. FIG. 6A shows an obtained SEM image, and FIG. 6B shows an image of an element analysis performed by the EDX.

From the above-described results, in the case where a connector is constituted by using the test piece of Example 1, it is expected that, even when tin that is the matrix phase is oxidized, the second phase that contains carbon as a main component, and that grows in a dendrite-like manner functions as an electrical conductive path, whereby lowering of the conductivity is suppressed, and the conductivity is maintained for a long period of time.

### Example 2

The conductive coating layer was formed on the metal base material in a method corresponding to the above-described third embodiment.

First, a copper plate and tin alloy wire that are identical with those used in Example 1 were prepared as the metal base material and the plating metal, and 2% hydrochloric acid was prepared as the plating bath. Then, the copper plate and the tin alloy wire were immersed in the plating bath, a voltage of from 0.7 to 1 V was applied between them, and a plating process was performed under conditions of a current value of from 0.02 to 0.04 A and from several minutes to one hour until formation of a plating layer was visually confirmed, to form a porous coating layer constituted by fine tin particles. Next, 0.5 mL of an oxidized graphene dispersed aqueous solution was applied onto the porous coating layer to permeate into open pores, and form a coat on the surface, and then drying was performed to obtain the constituting material of the second phase. Then, the copper plate on which the porous coating layer and the constituting material of the second phase are stacked was pressed for 30 seconds under conditions of the room temperature and 0.5 MPa by a pressure molding machine (manufactured by AS ONE CORPORATION, Type HP-1). Finally, the copper plate was heated at 200° C. for 30 minutes in a nitrogen atmosphere, and a test piece of Example 2 was obtained.

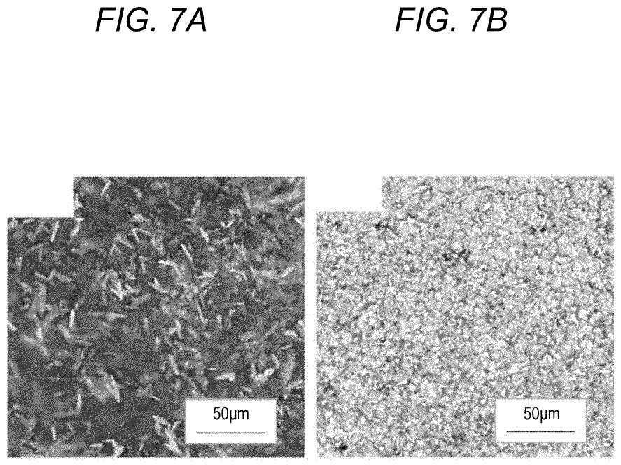

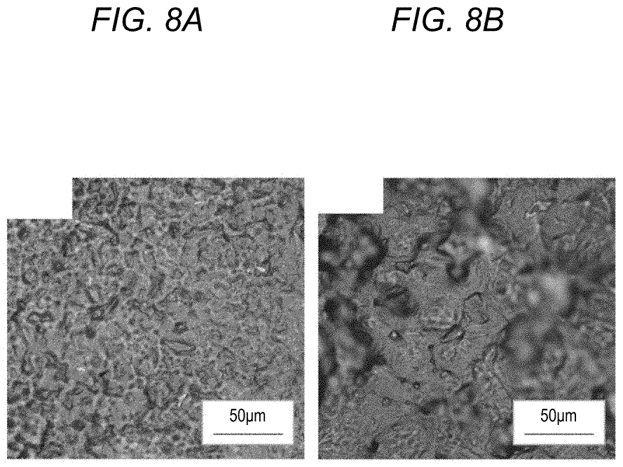

The surface of the porous coating layer which is formed on the copper plate, and to which the oxidized graphene was not yet applied was observed by an optical microscope (manufactured by Carl Zeiss Co., Ltd., Axioplan 2 imaging), As a result, a structure where acicular fine particles aggregate (FIG. 7A), and a structure including sponge-like tissues in which fine metal particles are coupled to one another, and net-like air spaces that are formed between the tissues (FIG. 7B) were confirmed. The surface of the test piece of Example 2 was observed in a similar method. As a result, a structure in which the air spaces between the above-described acicular fine particles are filled with the second phase (FIG. 8A), and a structure in which the above-described net-like air spaces are tilled with the second phase (FIG. 8B) were confirmed.

From the above-described results, in the case where a connector is constituted by using the test piece of Example 2, it is expected that, even when tin that is the matrix phase is oxidized, the three-dimensional net-like second phase that contains carbon as the main component functions as an electrical conductive path, whereby lowering of the conductivity is suppressed, and the conductivity is maintained for a long period of time. In the test piece of Example 2, the second phase has a three-dimensional net-like structure. Therefore, it is further expected that, even in the case where particles of the matrix phase that exist in the vicinity of the surface of the conductive coating layer shed, an electrical contact is enabled by the second phase that is newly exposed, and lowering of the conductivity is suppressed.

Example 3

The conductive coating layer was formed on the metal base material in a method corresponding to the above-described fifth embodiment.

First, a copper plate that is identical with that used in Example 1 was prepared as the metal base material, a nickel wire (Ni: 99.99%) of 1 mm Φ was prepared as the plating metal, and a dispersion liquid in which carbon black (manufactured by KURETAKE Co., Ltd.) is dispersed in 1% hydrochloric acid containing polyoxyalkylene alkyl ether that is a surfactant was prepared as the plating bath. Then, the copper plater and the nickel wire were immersed in the plating bath, a voltage of 1.2 V was applied between them, and a plating process was performed under conditions of a current value of 0.01 A and 60 minutes, to form the conductive coating layer, whereby a test piece of Example 3 was obtained. During the plating process, it was confirmed that bubbles were formed in the plating bath.

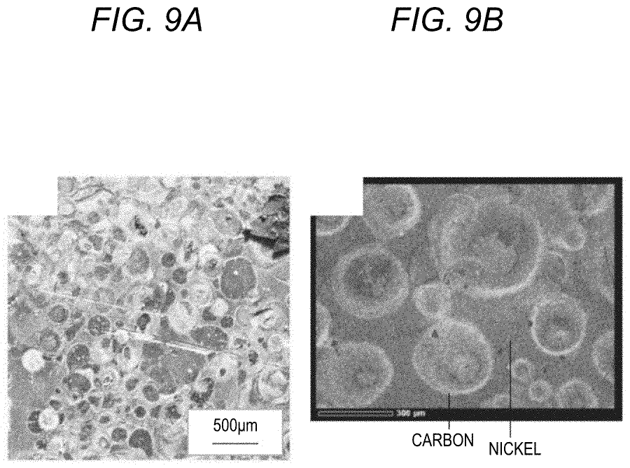

The surface of the conductive coating layer that is in the obtained test piece of Example 3 was observed in a method that is similar to that of Example 2, and it was confirmed that the bubble-like second phase is three-dimensionally coupled to each other to form a net-like structure. The composition of the conductive coating layer was checked in a method that is similar to that of Example 1, and it was confirmed that the matrix phase contains nickel as a main component, and the second phase contains carbon as a main component. FIG. 9A shows an obtained optical microscopic image, and FIG. 9B shows an image of an element analysis performed by the EDX.

From the above-described results, in the case where a connector is constituted by using the test piece of Example 3, it is expected that, even when nickel that is the matrix phase is oxidized, the three-dimensional net-like second phase that contains carbon as the main component functions as an electrical conductive path, whereby lowering of the conductivity is suppressed, and the conductivity is maintained for a long period of time. In the test piece of Example 3, the second phase has a three-dimensional net-like structure. Therefore, it is further expected that, even in the case where particles of the matrix phase that exist in the vicinity of the surface of the conductive coating layer shed, an electrical contact is enabled by the second phase that is newly exposed, and lowering of the conductivity is suppressed.

### Example 4

The conductive coating layer was formed on the metal base material a method corresponding to the above-described sixth embodiment.

First, a copper plate that is identical with that used in Example I was prepared as the metal base material, and tin powder (manufactured by KISHIDA CHEMICAL. Co., Ltd., mean particle diameter of 75 μm) was prepared as metal powder constituting the matrix phase of the conductive coating layer. Then, application and drying of an oxidized graphene aqueous solution (manufactured by ALLIANCE Biosystems, Inc., monolayer oxidized graphene GO-W-60) were repeated four times on the tin powder, whereby a coat of oxidized graphene was formed on the surface of tin particles constituting the tin powder. Next, the tin powder on which a coat of oxidized graphene is formed was placed on the copper plate, and a compression molding process was performed by using a table press machine to form a laminate having layers constituted by tin and the oxidized graphene, on the copper plate. Finally, the laminate was subjected to a heating and reduction process under conditions of 200° C. and 10 minutes in a nitrogen atmosphere, the oxidized graphene was reduced to graphene, and a test piece of Example 4 was obtained.

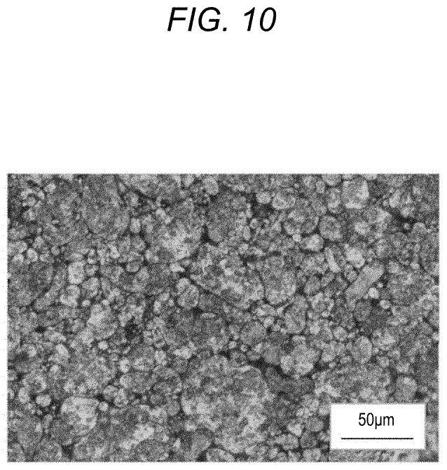

The surface of the conductive coating layer that is in the obtained test piece of Example 4 was observed in a method that is similar to that of Example 2, and the matrix phase constituted by aggregation of compression-deformed particles, and the second phase that coats the surfaces of the particles. that fills the air spaces between the particles, and that is formed in a three-dimensional net-like structure were confirmed. FIG. 10 shows an obtained optical microscopic image.

From the above-described results, in the case where a connector is constituted by using the test piece of Example 4, it is expected that, even when tin that is the matrix phase is oxidized, the three-dimensional net-like second phase that contains carbon as a main component functions as an electrical conductive path, whereby lowering of the conductivity is suppressed, and the conductivity is maintained for a long period of time. In the test piece of Example 4, the second phase has a three-dimensional net-like structure. Therefore, it is further expected that, even in the case where particles of the matrix phase that exist in the vicinity of the surface of the conductive coating layer shed, an electrical contact is enabled by the second phase that is newly exposed, and lowering of the conductivity is suppressed.

### Comparative Example 1

In order to confirm that the second phase having a three-dimensional net-like structure in the conductive coating layer attains the effect of protecting the matrix phase, a coating layer that does not include the second phase was produced, and corrosion resistances against an acid were compared to each other.

A test piece of Comparison example 1 was obtained in a method that is similar to that of Example 4, except that the surfaces of the tin particles constituting the tin powder were not coated by oxidized graphene, and that the reduction process was not performed on the laminate.

The test piece of Comparison example 1, and that of Example 4 were immersed for 16 days in a 3% hydrochloric acid aqueous solution, and their corrosion degrees were compared to each other. In the test piece of Comparison example 1, the mass reduction was 48%, and by contrast, in the test piece of Example 4, the mass reduction remained to be 35%. From the results, it can be said that the second phase that is formed in a three-dimensional net-like structure in the matrix phase contributes to the high conductivity of the conductive coating layer, and furthermore has a function of suppressing deterioration of the conductivity.

According to the invention, it is possible to provide a connector in which the conductivity is maintained for a long period of time. In the preferred embodiments of the invention in which the second phase forms a three-dimensional net-like structure in the conductive coating layer, it is possible to provide a connector in which deteriorations such as oxidation, and corrosion are suppressed. Therefore, the invention is useful in that a connector can be made highly durable and operate for a long time period. In the above-described coating layer in which the second phase forms a three-dimensional net-like structure, or the whole surface is coated by the second phase, even in the case where, for example, a civil or architectural structure, a plant, a vehicle, an artificial bone or tooth, or the like other than connectors is used as the base material, an effect in which the conductive coating layer protects such an article from deterioration factors can be expected.

### REFERENCE SIGN LIST

1 electrical contact material
2 metal base material
3 conductive coating layer
31 matrix phase
32 second phase
321 elongated portion
322 enlarged diameter portion

What is claimed is:

1. A connector comprising an electrical contact material which contains a metal base material and a conductive coating layer on a surface of the metal base material, wherein
the conductive coating layer includes:
a matrix phase constituted by a metal other than gold; and
a second phase that includes: elongated portions that elongate in a depth direction from a surface of the matrix phase; and enlarged diameter portions that, in the surface of the matrix phase, extend from the elongated portions along the surface, in which the second phase is constituted by gold or a non-metal conductive material that is less oxidizable than the metal constituting the matrix phase.

2. The connector according to claim 1, wherein the enlarged diameter portions cover a whole surface of the matrix phase.

3. The connector according to claim 1, wherein the second phase is constituted by a carbon material.

4. The connector according to claim 3, wherein the carbon material is a graphene and/or a carbon nanotube.

5. The connector according to claim 1, wherein the elongated portions form a three-dimensional net-like structure.

6. A method for producing the connector according to claim 1 comprising forming the conductive coating layer by:
preparing a plating bath containing a component element of the second. phase; and
performing an electroplating process in which the metal base material is immersed in the plating bath to obtain a plating layer in which the second phase grows in a dendrite-like manner in the matrix phase.

7. A method for producing the connector according to claim 1 comprising forming the conductive coating layer by:
preparing a plating bath;
performing an electroplating process in which the metal base material is immersed in the plating bath to obtain a porous plating layer constituted by an aggregation of fine particles having a composition of the matrix phase; and
filling open pores of the porous plating layer and covering at least a part of the surface of the porous plating layer with a material constituting the second phase or a precursor of the material.

8. A method for producing the connector according to claim 1 comprising forming the conductive coating layer by:
preparing a plating bath containing a component element of the second phase; and
performing an electroplating process in which the metal base material is immersed in the plating bath to obtain a plating layer constituted by fine particles having a composition of the matrix phase, and a material constituting the second phase or a precursor of the material which fill spaces between the fine particles.

9. A method for producing the connector according to claim 1 comprising forming the conductive coating layer by:
preparing a plating bath containing a component element of the second phase; and
performing an electroplating process in which the metal base material is immersed in the plating bath, under conditions where bubbles or convection is formed in the plating bath, to obtain a plating layer that includes the second phase having a shape in which bubbles or stripes are coupled to one another, in the matrix phase.

10. A method for producing the connector according to claim 1 comprising forming the conductive coating layer by:
preparing powder of the metal constituting the matrix phase;
coating surfaces of particles constituting the powder by a material constituting the second phase or a precursor of the material; and
placing the powder of the coated particles on the metal base material, and pressing and heating the powder of the coated particles to perform a molding process.
